(19) United States
(12) Patent Application Publication
(10) Pub. No.: US 2010/0227718 A1
(43) Pub. Date: Sep. 9, 2010

(54) Bicycle chain hanger

(76) Inventor: Bo-Sian Chen, Hsin Chu City (TW)

Correspondence Address: Bo-Sian CHEN, P.O. BOX 7-820, TAIPEI, TW

(21) Appl. No.: 12/380,644

(22) Filed: Mar. 3, 2009

(51) Int. Cl. F16H 9/00

(52) U.S. Cl. 474/79

(57) ABSTRACT

The present invention relates to a bicycle chain hanger, comprising a gear set, a slide bushing, a spring, a nut, and a quick removal wrench. The improvement comprising the gear is provided with wheel covers, inner rings, and snap rings on the two sides, a slide bushing passes through the inner ring, the middle section of one end of the slide bushing is provided with an outer expansion ring so that a spring can be put on the front screw of the quick removal wrench and locked with the nut on the other end through the bore of the bushing, therefore limiting the gear to rotate between the outer expansion ring and the nut; then, the other end of the slide bushing is put into the rear wheel axle hook of the bicycle and positioned with the quick removal wrench to replace the change gear set so that the chain can be cleaned conveniently.

### BACKGROUND OF THE INVENTION

Ordinary bicycle sports equipment has become the latest best-selling product presently as it is environmentally friendly and provides the sports & fitness functions. However, the invention applicant has learned through investigation that the bicycles are steered to move forward by a transmission chain driving the change gear set of the rear wheel and plenty of dust and foreign materials may build up after long-term use as a result of the open frame, leading to friction between the gears and inaccurate speed change and therefore the chains must be cleaned with cleaner from time to time. However, the cleaner and the dust dissolved will enter the ratchet seat through the change gear set, which is provided with the precision lubricating bearing and the ratchet may lose its lubricating function after long-term washing, making it necessary to make improvements.

### SUMMARY OF THE INVENTION

The primary purpose of the present invention is to provide a bicycle chain hanger and in particular one that comprises a gear set, a slide bushing, a spring, a nut, and a quick removal wrench and is able to replace the traditional change gear set directly so that the chain can be hung rapidly for cleaning.

The secondary purpose of the present invention is to provide a bicycle chain hanger, wherein the gear is provided with wheel covers, inner rings, and snap rings on the two sides so that the chain will not run off when hung.

One more purpose of the present invention is to provide a bicycle hanger, where a slide bushing passes through the inner ring of the gear set, the middle section of one end of the slide bushing is provided with an outer expansion ring so that a spring can be put on the front screw of the quick removal wrench and locked with the nut on the other end through the bore of the bushing, therefore limiting the gear to rotate between the outer expansion ring and the nut.

Another purpose of the present invention is to provide a bicycle chain hanger, wherein a spring is provided between the front removal wrench of the quick removal wrench and the slide bushing so that the spring can extend and retract where necessary and the hook of the rear wheel axle of the bicycle is positioned.

### BRIEF DESCRIPTION OF THE DRAWINGS

FIG. 1 is a 3D diagram of the present invention.

FIG. 2 is a schematic diagram of the components of the present invention.

FIG. 3 is a cross-section 3D diagram of the present invention.

FIG. 4 is a schematic of the present invention showing that the nut limits the gear set between the outer expansion ring and the nut.

FIG. 5 is the schematic of the quick removal wrench of the present invention squeezing the pressing block to be positioned.

### DETAILED DESCRIPTION OF THE PREFERRED EMBODIMENT

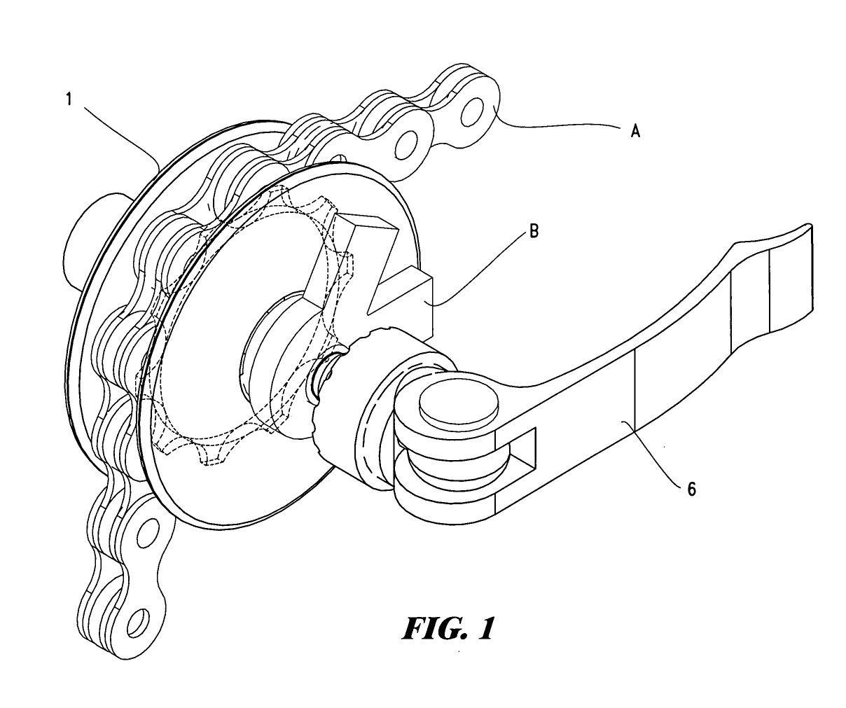

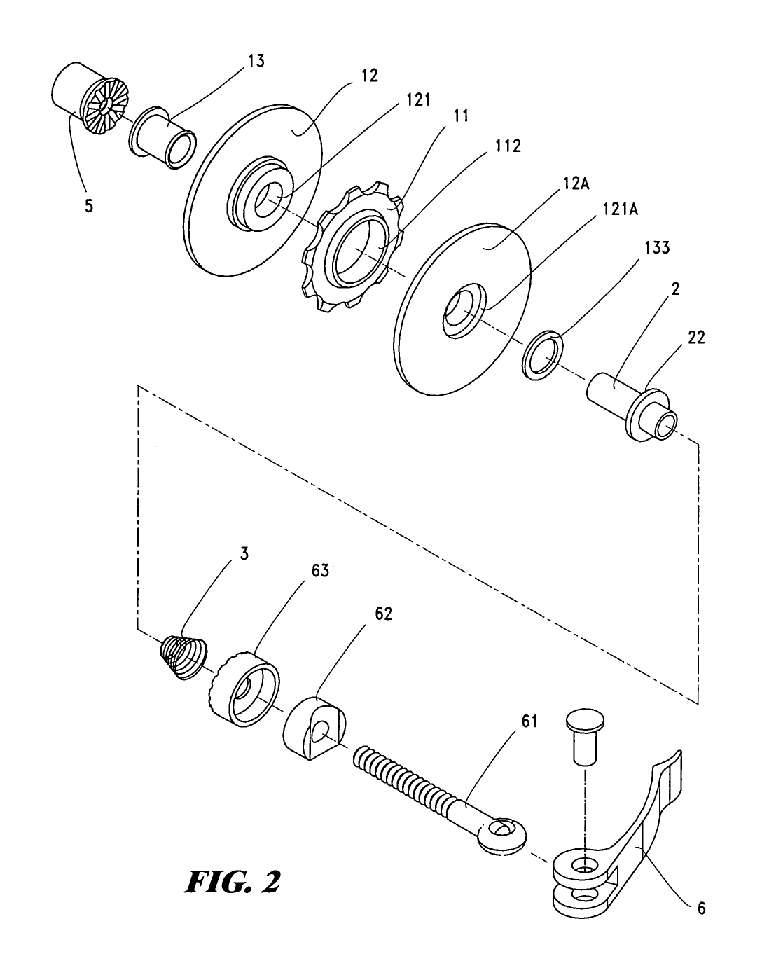

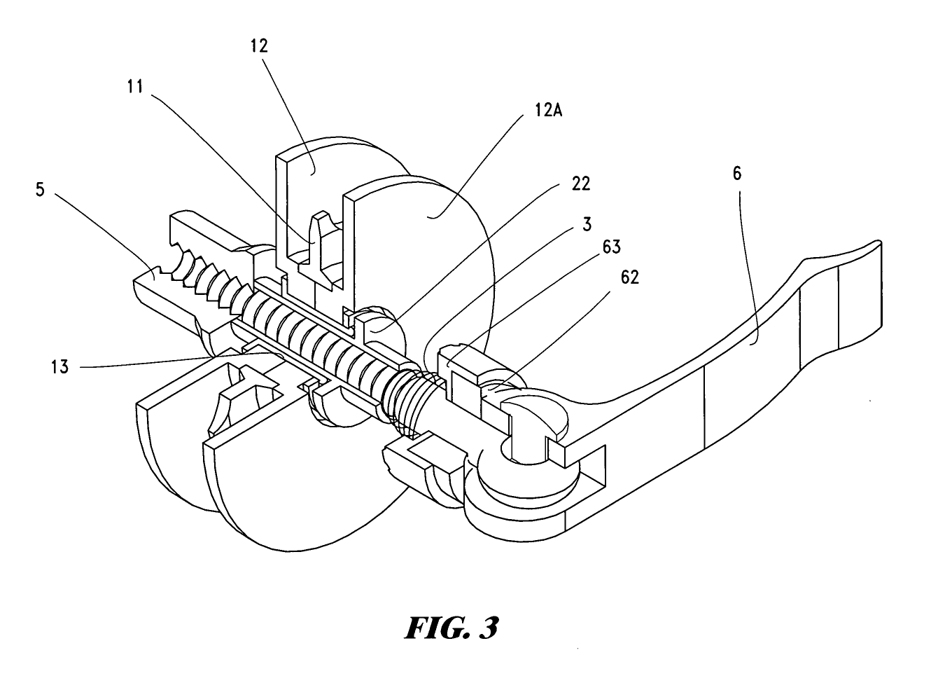

Please refer to FIGS. 1 through FIGS. 3, the bicycle chain hanger of the present invention, comprising gear set 1, slide bushing 2, spring 3, nut 5 and quick removal wrench 6, wherein gear set 1 comprises gear 11, two wheel covers 12 and 12A, inner ring 13 and snap ring 133, gear 11 is a body available for the hanging and rotation of chain A; the two wheel covers 12 and 12A are wheel covers whose outer diameter is slightly larger than that of gear 11 and whose inner diameter are projected with ladder rings 121 and 121A to be combined into gear bore 112; inner ring 13 has an outer expansion ring provided on one end and ladder rings 121 and 121A of the two wheel covers 12 and 12A provided on the other end; snap ring 133 is a round ring for the installation of the other end of inner ring 13; slide bushing 2 is a hollow bushing with an outer expansion ring 22 provided in the middle of one end and the longer bushing on one end is installed into inner ring 13 to slide; spring 3 is a flexible tapered spring; nut 5 is a nut with thread 52 provided on one side; quick removal wrench 6 is a quick removal wrench whose front end comprises screw 61, pressing block 62, and anti-skid ring cover 63; screw 61 is provided for threading through the above spring 3, slide bushing 2, and inner ring 13 of gear set 1 and for locking by nut 5 to limit gear set 1 to rotate between outer expansion ring 22 and nut 5.

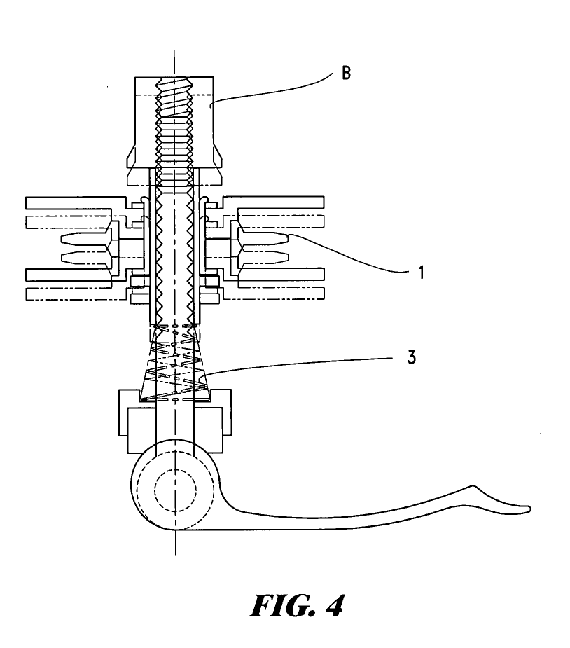

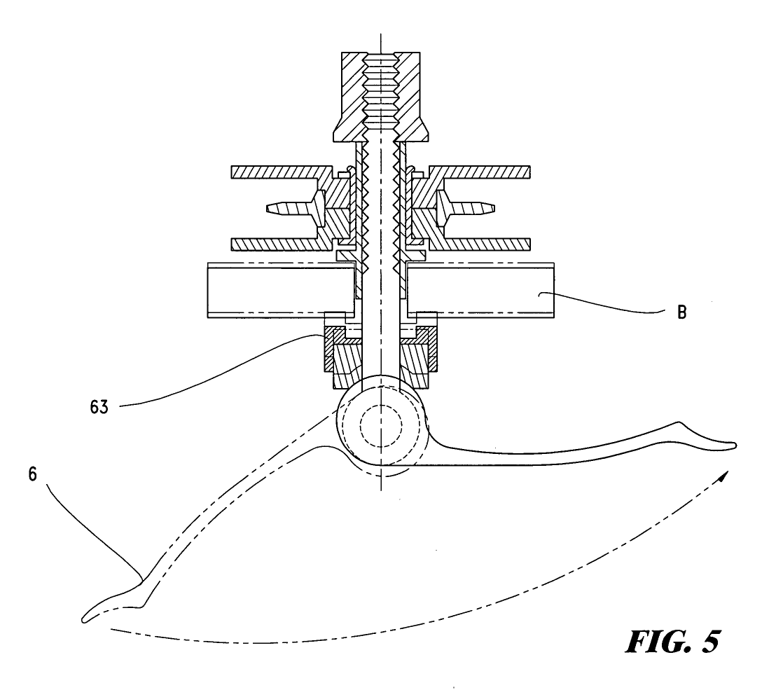

Please refer to FIGS. 4 and FIGS. 5 for one embodiment of this invention. The bicycle chain hanger comprises gear set 1, slide bushing 2, spring 3, nut 5, and quick removal wrench 6 so that screw 61 is put into hook B of the rear wheel axle of the bicycle, quick removal wrench 6 is bent back to squeeze pressing block 62, anti-skid ring cover 63 and outer expansion ring 22 on slide bushing 2 are attached to hook B and replace the change gear set, and chain A can be hung rapidly so that the chain can be cleaned conveniently.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changers in the forms and details of the device illustrated and in its operation can be made by those skilled in the art without departing in any way from the spirit of the present invention.

I claim:

1. A bicycle chain hanger, comprising a gear set, a slide bushing, a nut and a quick removal wrench, etc, wherein:
The gear set comprises a gear, two wheel covers, an inner ring and a snap ring; the gear is a body available for the hanging and rotation of the chain; the two wheel covers are wheel covers whose outer diameter is slightly larger than that of the gear and whose inner diameter are projected with ladder rings for to be combined into the gear bore; the inner ring has an outer expansion ring provided on one end and the ladder rings of two wheel covers provided on the other end; the snap ring is a round ring for the installation of the other end of the inner ring;
The slide bushing is a hollow bushing with an outer expansion ring provided in the middle of one end and the longer bushing on one end is installed into the inner ring to slide;
The spring is a flexible tapered spring;
The nut is a nut with thread provided on one side;
The nut is locked into the screw hole on the other end of the slide bushing to limit the gear between the outer expansion ring and the nut;
The quick removal wrench is a quick removal wrench whose front end comprises a screw, a pressing block, and an anti-skid ring cover; the screw is provided for threading through the above spring, the slide bushing, and the inner ring of the gear set and for locking by the nut to limit the gear set to rotate between the outer expansion ring and the nut;
Through the above structure, the screw is put into the hook of the rear wheel axle of the bicycle, the quick removal wrench is bent back to squeeze the pressing block, the anti-skid ring cover and the outer expansion ring on the slide bushing are attached to hook and replace the change gear set, and the chain can be hung rapidly so that the chain can be cleaned conveniently.
